(19) United States
(12) Patent Application Publication
(10) Pub. No.: US 2009/0293663 A1
(43) Pub. Date: Dec. 3, 2009

(54) Robot arm

(75) Inventors: Ehr-Chou Chang, Kaohsiung City (TW); Jia-Chi He, Kaohsiung City (TW)

Correspondence Address: DLA PIPER LLP (US ), 2000 UNIVERSITY AVENUE, EAST PALO ALTO, CA, 94303-2248, US

(73) Assignee: Advanced International Multitech Co., Ltd., Kaohsiung City (TW)

(21) Appl. No.: 12/313,296

(22) Filed: Nov. 18, 2008

(30) Foreign Application Priority Data
May 28, 2008 (TW) 097119663
May 28, 2008 (TW) 097209323

(51) Int. Cl. B25J 18/00; B25J 9/00; B32B 1/08; B32B 5/02

(52) U.S. Cl. 74/490.01; 414/680; 428/36.91; 901/27; 901/19

(57) ABSTRACT

A robot arm includes a working arm member, a workpiece placement unit, and a driving device. The workpiece placement unit includes a base seat coupled to the working arm member, and a hollow supporting rod with a suction unit. The supporting rod extends from the base seat, is adapted for supporting a workpiece thereon, and defines a passage therethrough. The supporting rod is made of a composite material including a hollow rod structure having at least one fibrous layer that is made of resin-impregnated carbon prepreg, and an outer covering layer made of fiberglass material and covering an outer surface of the hollow rod structure. The driving device is coupled to the working arm member, is operable to drive the working arm member for moving the workpiece placement unit, and is further operable for extracting air from the passage so that the workpiece supported by the supporting rod is held in position by the suction unit.

### CROSS-REFERENCE TO RELATED APPLICATION

This application claims priorities of Taiwanese Application No. 097119663, filed on May 28, 2008, and Taiwanese Application No. 097209323, filed on May 28, 2008.

### BACKGROUND OF THE INVENTION

1. Field of the Invention

The invention relates to a robot arm, more particularly to a robot arm adapted for supporting a workpiece thereon.

2. Description of the Related Art

As shown in FIG. 1, a conventional robot arm 1 is adapted for supporting glass substrates 100 thereon, and includes a working arm member 12, a supporting unit 13 coupled to the working arm member 12, and a driving device 11 for driving the working arm member 12 to move the supporting unit 13.

As further shown in FIGS. 2 and 3, the supporting unit 13 includes a base seat 131 coupled to the working arm member 12, and a plurality of parallel and spaced-apart hollow supporting rods 132 extending from the base seat 131. Each of the supporting rods 132 includes a hollow rod structure having a plurality of fibrous layers 133 made of resin-impregnated carbon prepreg and defining a passage 130 therethrough, and a plurality of spaced-apart suction units 134, each of which has one end that extends through the fibrous layers 131 and that is in fluid communication with the passage 130. The driving device 11 is further operable for extracting air from the passage 130 in each of the supporting rods 132 of the supporting unit 13 so that the glass substrates 100 supported by the supporting rods 132 are held in position by the suction units 134.

When manufacturing the conventional robot arm 1, a resin-impregnated carbon prepreg is hot-pressed to form the supporting rods 132. However, since the resin-impregnated carbon prepreg has relatively large pores, resin in the resin-impregnated carbon prepreg is likely to leak via the pores during the hot-pressing process, thereby resulting in a rough outer surface of the supporting rods 132. In use, dents and holes in the outer surface of the supporting rods 132 are likely to accumulate dust therein. Moreover, the dust accumulated in the dents and holes of the supporting rods 132 may scrape the glass substrates 100 held on the supporting rods 132, thereby affecting adversely the production yield of the glass substrates 100.

### SUMMARY OF THE INVENTION

Therefore, the object of the present invention is to provide a robot arm that can alleviate accumulation of dust thereon, and that can lower the possibility of scraping workpieces held thereon.

Accordingly, a robot arm of the present invention is adapted for supporting a workpiece thereon. The robot arm comprises a working arm member, a workpiece placement unit, and a driving device. The workpiece placement unit includes a base seat, and a hollow supporting rod. The base seat is coupled to the working arm member. The supporting rod extends from the base seat, is adapted for supporting the workpiece thereon, and defines a passage therethrough. The supporting rod is made of a composite material including a hollow rod structure that has at least one fibrous layer made of resin-impregnated carbon prepreg and that has inner and outer surfaces, and an outer covering layer that is made of fiberglass material and that covers the outer surface of the hollow rod structure. The supporting rod further includes a suction unit that extends through the hollow rod structure and the outer covering layer of the supporting rod, that has a workpiece contacting end projecting from the outer covering layer of the supporting rod, and that is in fluid communication with the passage in the supporting rod. The driving device is coupled to the working arm member, is operable to drive the working arm member for moving the workpiece placement unit, and is further operable for extracting air from the passage in the supporting rod of the workpiece placement unit so that the workpiece supported by the supporting rod is held in position by the suction unit.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic side view of a conventional robot arm;

FIG. 2 is an enlarged fragmentary schematic top view of a supporting unit of the conventional robot arm;

FIG. 3 is an enlarged sectional view of the conventional robot arm, illustrating a supporting rod thereof;

FIG. 4 is a side view of a first preferred embodiment of a robot arm according to the present invention;

FIG. 5 is a perspective view of a workpiece placement unit of the first preferred embodiment;

FIG. 6 is an enlarged sectional view of the first preferred embodiment, illustrating a supporting rod thereof; and

FIG. 7 is an enlarged sectional view of a second preferred embodiment of the robot arm according to the present invention, illustrating a supporting rod thereof.

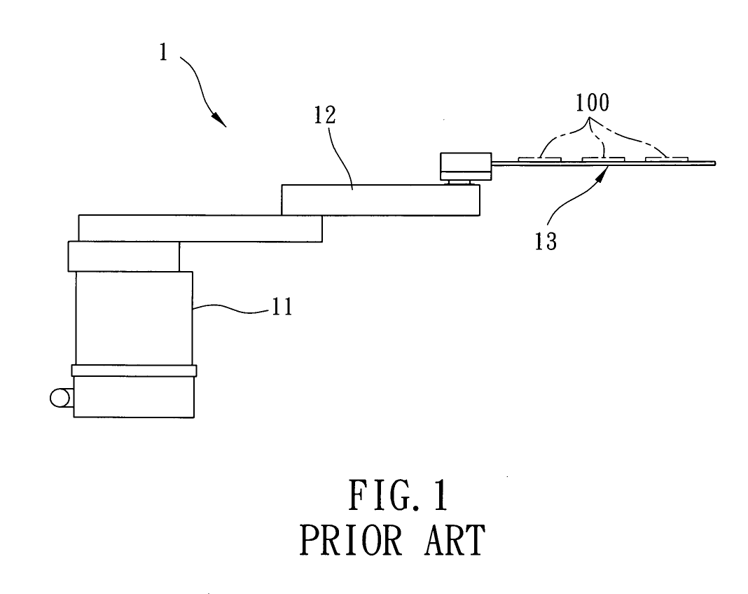

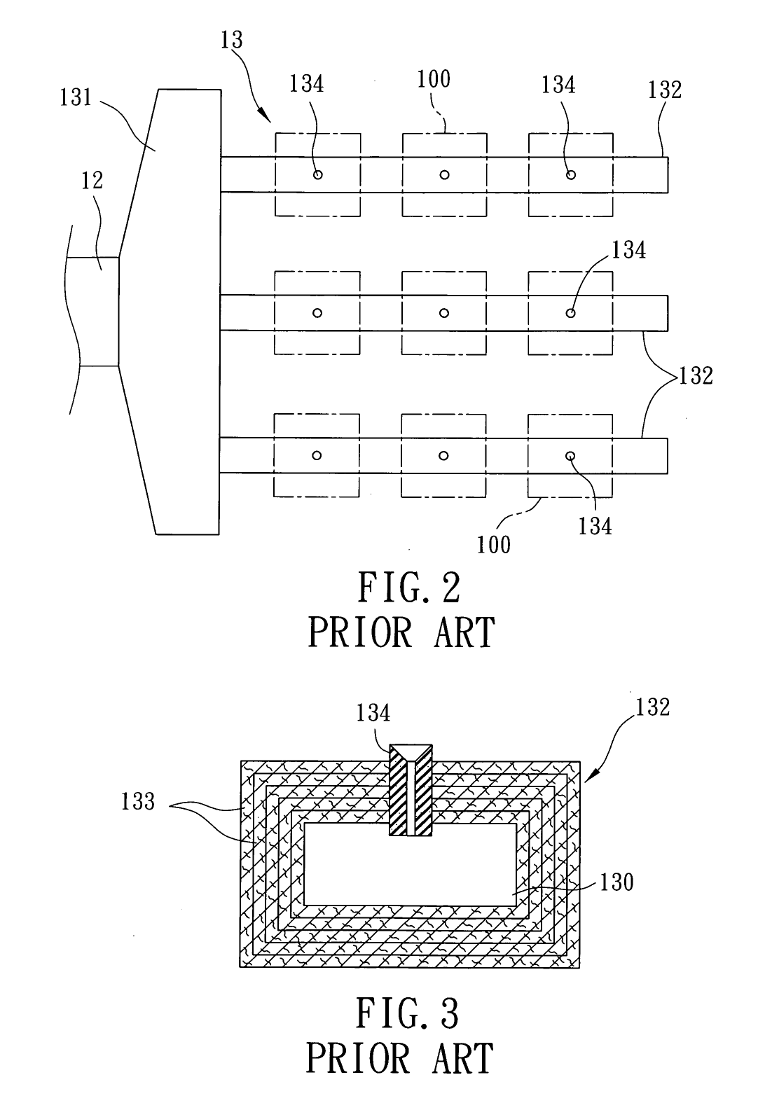

### DETAILED DESCRIPTION OF THE PREFERRED EMBODIMENTS

Before the present invention is described in greater detail, it should be noted that like elements are denoted by the same reference numerals throughout the disclosure.

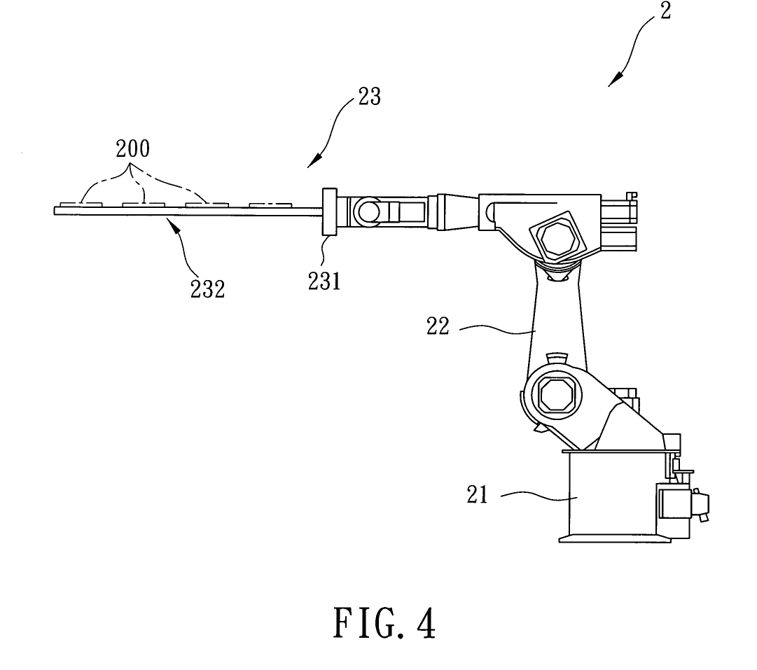

As shown in FIG. 4, the first preferred embodiment of a robot arm 2 according to the present invention is adapted for supporting workpieces 200 thereon. The robot arm 2 comprises a driving device 21, a working arm member 22, and a workpiece placement unit 23.

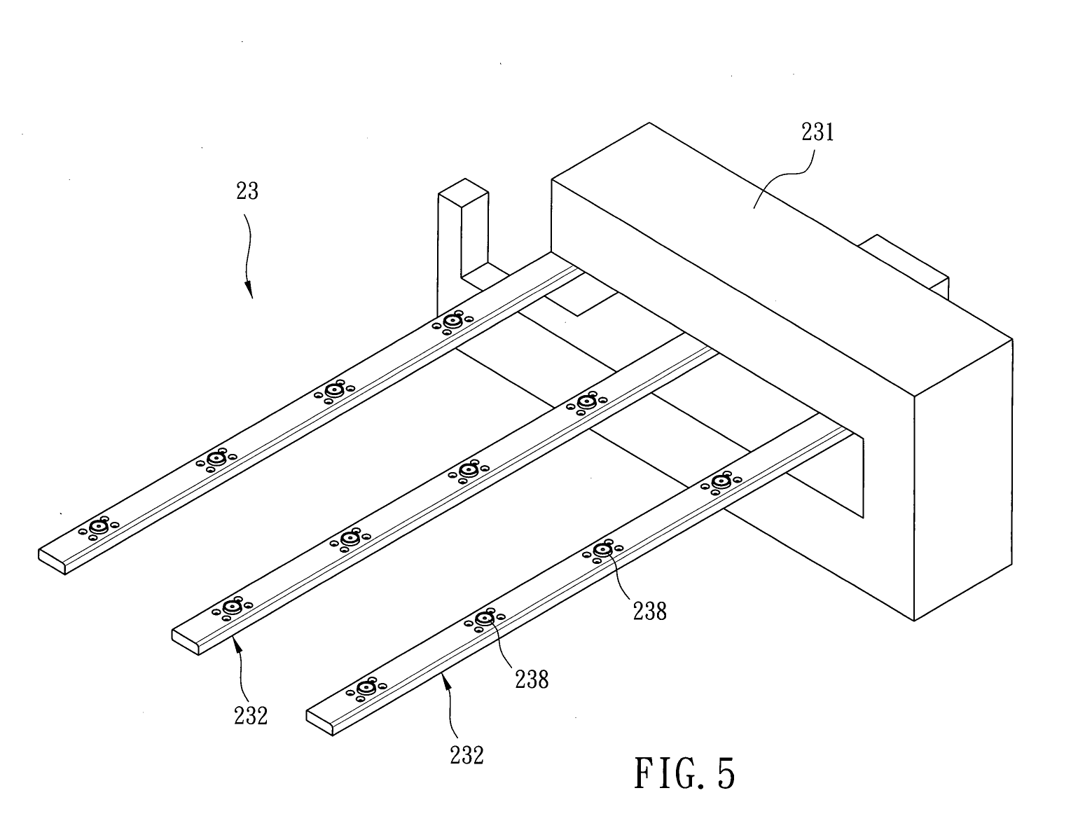

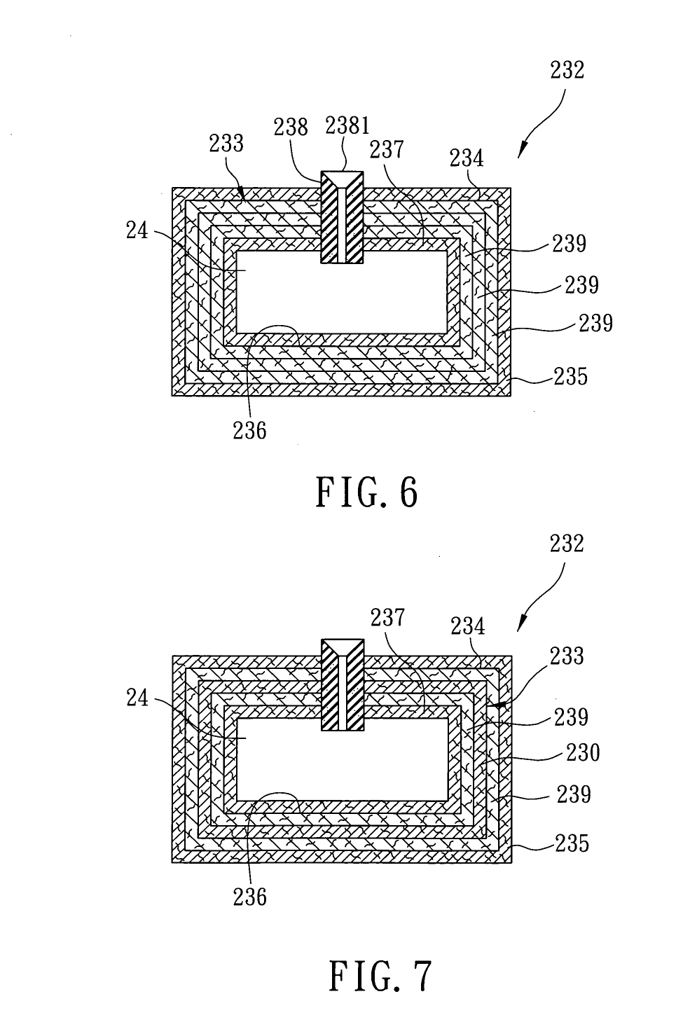

As further shown in FIGS. 5 and 6, the workpiece placement unit 23 includes a base seat 231 coupled to the working arm member 22, and a plurality of parallel and spaced-apart hollow supporting rods 232. Each of the supporting rods 232 extends from the base seat 231, is adapted for supporting a plurality of the workpieces 200 thereon, and defines a passage 24 therethrough. In this embodiment, each of the supporting rods 232 is made of a composite material including a hollow rod structure 233 that has a plurality of fibrous layers 239 made of resin-impregnated carbon prepreg and that has inner and outer surfaces 236, 234, an outer covering layer 235 that is made of fiberglass material and that covers the outer surface 234 of the hollow rod structure 233, and an inner covering layer 237 that is made of fiberglass material, that covers the inner surface 236 of the hollow rod structure 233, and that defines the passage 24. Each of the supporting rods 232 further includes a plurality of spaced-apart suction units 238, each of which extends through the hollow rod structure 233 and the inner and outer covering layers 237, 235, and has a workpiece contacting end 2381 projecting from the outer covering layer 235, and an end opposite to the workpiece contacting end 2381 and in fluid communication with the passage 24.

The driving device 21 is coupled to the working arm member 22, is operable to drive the working arm member 22 for moving the workpiece placement unit 23 in a conventional manner, and is further operable in a conventional manner for extracting air from the passage 24 in each of the supporting rods 232 of the workpiece placement unit 23 so that the workpieces 200 supported by the supporting rods 232 are held in position by the suction units 238.

It should be noted that, while this invention is exemplified using a plurality of the supporting rods 232, only one supporting rod 232 maybe employed in other embodiments of this invention. Moreover, each of the supporting rods 232 may include only one suction unit 238 adapted for holding one workpiece 200 thereon in other embodiments of this invention.

When manufacturing the robot arm 2 of the first preferred embodiment, each of the supporting rods 232 of the workpiece placement unit 23 is formed through a hot-pressing process. Since the inner and outer covering layers 237, 235 are made of fiberglass material having pores smaller than those of resin-impregnated carbon prepreg, they can effectively minimize leakage of the resin in the fibrous layers 239 during the hot-pressing process, thereby resulting in fewer dents and holes in the outer covering layer 235, and thereby alleviating dust accumulation on the supporting rods 232. Moreover, the alleviation of dust accumulation reduces the possibility of scraping the workpieces 200 held on the supporting rods 232, thereby effectively minimizing any adverse affect on the production yield of the workpieces 200.

Referring to FIG. 7, the second preferred embodiment of the robot arm 2 according to the present invention has a structure similar to that of the first embodiment. The main difference between this embodiment and the previous embodiment resides in the configuration of each of the supporting rods 232. In this embodiment, each of the supporting rods 232 has a hollow rod structure 233 that includes a pair of fibrous layers 239 made of resin-impregnated carbon prepreg, and a fiberglass interlayer 230 disposed between the fibrous layers 239. Compared to the previous embodiment, the presence of the fiberglass interlayer 230 further prevents leakage of the resin in the fibrous layers 239 during the hot-pressing process. Therefore, the second preferred embodiment has the same advantages as those of the first preferred embodiment.

The composite material from which the supporting rods 232 of the robot arm 2 are made is also suitable for forming composite boards, which may be flat or curved.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A robot arm adapted for supporting a workpiece thereon, said robot arm comprising:
a working arm member;
a workpiece placement unit including
a base seat that is coupled to said working arm member, and
a hollow supporting rod that extends from said base seat, that is adapted for supporting the workpiece thereon, and that defines a passage therethrough, said supporting rod being made of a composite material including a hollow rod structure that has at least one fibrous layer made of resin-impregnated carbon prepreg and that has inner and outer surfaces, an outer covering layer that is made of fiberglass material and that covers said outer surface of said hollow rod structure, and a suction unit that extends through said hollow rod structure and said outer covering layer of said supporting rod, that has a workpiece contacting end projecting from said outer covering layer of said supporting rod, and that is in fluid communication with said passage in said supporting rod; and
a driving device coupled to said working arm member, operable to drive said working arm member for moving said workpiece placement unit, and further operable for extracting air from said passage in said supporting rod of said workpiece placement unit so that the workpiece supported by said supporting rod is held in position by said suction unit.

2. The robot arm as claimed in claim 1, wherein:
said supporting rod further includes an inner covering layer that is made of fiberglass material, that covers said inner surface of said hollow rod structure, and that defines said passage; and
said suction unit further has one end that is opposite to said workpiece contacting end and that extends through said inner covering layer.

3. The robot arm as claimed in claim 2, wherein said hollow rod structure of said supporting rod includes a pair of said fibrous layers and a fiberglass interlayer that is disposed between said fibrous layers.

4. A composite material for a supporting rod in a robot arm, the supporting rod is disposed for supporting a workpiece thereon, said composite material comprising:
a fibrous structure having at least one fibrous layer that is made of resin-impregnated carbon prepreg, and having opposite first and second surfaces; and
a first covering layer made of fiberglass material and covering said first surface of said fibrous structure.

5. The composite material as claimed in claim 4, wherein said fibrous structure has a pair of said fibrous layers and a fiberglass interlayer that is disposed between said fibrous layers.

6. The composite material as claimed in claim 5, further comprising a second covering layer that is made of fiberglass material and that covers said second surface of said fibrous structure.

7. The composite material as claimed in claim 4, further comprising a second covering layer that is made of fiberglass material and that covers said second surface of said fibrous structure.
